(19) United States
(12) Patent Application Publication
(10) Pub. No.: US 2006/0061218 A1
(43) Pub. Date: Mar. 23, 2006

(54) Dual force wafer table

(75) Inventor: Andrew J. Hazelton, Yokohama (JP)

Correspondence Address: AKA CHAN LLP, 900 LAFAYETE STREET, SUITE 710, SANTA CLARA, CA, 95050, US

(73) Assignee: Nikon Corporation, Tokyo (JP)

(21) Appl. No.: 11/047,850

(22) Filed: Jan. 31, 2005

Related U.S. Application Data
(60) Provisional application No. 60/611,588, filed on Sep. 21, 2004.

(51) Int. Cl. H02K 41/00; G03B 27/42

(52) U.S. Cl. 310/12; 318/135; 355/53; 355/72

(57) ABSTRACT

Methods and apparatus for actuating a tubeless fine stage using E-I core actuators and voice coil motors (VCMs) are described. According to one aspect of the present invention, a stage device includes a first stage, an air bearing arrangement with at least one air bearing, and a second stage. The second stage has six degrees of freedom, and is supported relative to the first stage in a first degree of freedom. A first actuator arrangement provides a force to drive the second stage in the first degree of freedom, and a second actuator arrangement drives the second stage in at least a first planar degree of freedom. A third actuator arrangement controls the second stage in the first and second planar degrees of freedom. The third actuator arrangement also controls the second stage in a first rotational degree of freedom about an axis associated with the first degree of freedom.

### CROSS REFERENCE TO RELATED PATENT APPLICATION

The present invention claims priority to co-pending U.S. Provisional Patent Application No. 60/611,588, filed Sep. 21, 2004, which is incorporated herein by reference in its entirety.

### BACKGROUND OF THE INVENTION

1. Field of Invention

The present invention relates generally to semiconductor processing equipment. More particularly, the present invention relates to a dual force wafer table with a fine stage with six degrees of freedom that is supported by air bearings and may be precisely controlled in at least three degrees of freedom.

2. Description of the Related Art

For precision instruments such as photolithography machines which are used in semiconductor processing, factors which affect the performance, e.g., accuracy, of the precision instrument generally must be dealt with and, insofar as possible, eliminated. By way of example, excessive heat generated by actuators of a wafer stage apparatus often adversely affects the performance of the wafer stage. Excessive vibrations may also compromise the performance of the wafer stage. When the performance of a precision instrument such as a wafer table is adversely affected, products formed using the precision instrument may be improperly formed and, hence, function improperly.

Some wafer stage devices include fine stages which have substantially no mechanical connections to the coarse stages below them. A fine stage or a wafer table which has no mechanical connections to a coarse stage may supported in a z-direction, or vertical direction, by air bearings, such that there are no wires or tubes between the fine stage and the coarse stage. The fine stage is generally driven in planar degrees of freedom with electromagnetic actuators, and is a ceramic box structure which provides a relatively high stiffness. When linear motors or voice coil motors (VCMs) are used as the actuators to drive the fine stage such that the fine stage accelerates or decelerates, the relatively high amount of heat generated by the actuators may compromise the accuracy with which positioning may occur.

As VCMs are generally characterized by high accuracy but relatively low efficiency, some wafer stage devices utilize VCMs to generate a relatively low force with low electromagnetic stiffness during a high accuracy, constant velocity portion of a scan involving a fine stage while utilizing less accurate but more efficient actuators to generate a relatively high force during acceleration and deceleration. Such wafer stage devices may use electromagnetic actuators, for example E-I core actuators, which have a relatively high efficiency and generate relatively little heat, during a lower accuracy, accelerating portion of a scan and VCMs during the high accuracy portion of the scan. E-I core actuators have a non-constant force as a function of position and, as a result, must be commutated. Any error in commutation will generally manifest itself as a stiffness of the actuator, thereby causing vibration transmission between the coarse stage and the fine stage. As a result, for relatively high accuracy scanning, E-I core actuators may not be preferred.

Therefore, what is needed is a method and an apparatus for enabling a fine stage that has no mechanical connections to a coarse stage to be precisely controlled without generating a significant amount of heat or a significant amount of vibrations.

### SUMMARY OF THE INVENTION

The present invention relates to a fine stage which has no mechanical connections to a coarse stage and is arranged to be actuated in at least one degree of freedom in which the fine stage is supported by an air bearing. According to one aspect of the present invention, a stage device includes a first stage, an air bearing arrangement with at least one air bearing, and a second stage. The second stage has six degrees of freedom, and is supported relative to the first stage in a first degree of freedom. The stage device also includes a first actuator arrangement that provides a force to drive the second stage in the first degree of freedom, a second actuator arrangement that drives the second stage in at least a first planar degree of freedom, and a third actuator arrangement that controls the second stage in the first planar degree of freedom and a second planar degree of freedom. The third actuator arrangement also controls the second stage in a first rotational degree of freedom about an axis associated with the first degree of freedom.

In one embodiment, the second actuator arrangement includes at least a first electromagnetic actuator which produces a relatively high force and the third actuator arrangement includes at least a second electromagnetic actuator which produces a relatively low force. In such an embodiment, the first electromagnetic actuator may be an E-I core actuator and the second electromagnetic actuator may be a voice coil motor (VCM).

A six-degree of freedom tubeless fine stage of a stage device which has substantially no mechanical connections with a coarse stage of the stage device, and is supported by air bearings, may be actuated by a VCM in at least one degree of freedom that is supported by the air bearings. Such a fine stage may effectively be a dual force fine stage or wafer table, as high efficiency E-I core actuators and high accuracy VCMs may be used as appropriate to position the fine stage. The efficiency of an E-I core actuator may effectively be exploited during acceleration and deceleration of a fine stage when accuracy is less important, while the accuracy of benefit from the accuracy of VCMs during precise positioning of the fine stage when efficiency is less important. One wafer stage device which utilizes both E-I core actuators and VCMs is described in commonly assigned co-pending U.S. patent application Ser. No. 09/876,431, which is incorporated herein by reference in its entirety.

According to another aspect of the present invention, a method for positioning an object using a fine stage which has no mechanical connection to the coarse stage and supports an object includes imparting acceleration on the fine stage to cause the fine stage to accelerate in at least one of an x-direction and a y-direction using a relatively high force actuator arrangement. The method also includes imparting at least one approximately constant velocity on the fine stage using a relatively low force actuator arrangement to cause the fine stage to move in any or all of the x-direction, the y-direction, and a rotational direction about a z-direction in which the fine stage is supported over the coarse stage by an air bearing arrangement. A velocity is imparted on the fine stage using at least a first actuator that causes the fine stage to translate in the z-direction in which the fine stage is supported by the air bearing arrangement. In one embodiment, the relatively high force actuator arrangement includes at least one E-I core actuator and the relatively low force actuator arrangement includes at least one VCM.

In accordance with another aspect of the present invention, a stage device includes a surface, an air bearing arrangement having at least one air bearing, and a fine stage. The fine stage has approximately six degrees of freedom, and is supported relative to the surface in a first translational direction by the air bearing arrangement. A first VCM provides a force to actuate the fine stage in the first translational direction, and an E-I core actuator arrangement provides an acceleration to drive the fine stage in at least a second translational direction. A VCM arrangement, which includes at least a second VCM, drives the fine stage in at least one of the second translational direction, a third translational direction, and a first rotational direction that is about an axis associated with the first translational direction.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is block diagram representation of a fine stage that is supported on a coarse stage by an air bearing arrangement in accordance with an embodiment of the present invention.

FIG. 2 is a process flow diagram which illustrates one method of positioning a fine stage that is supported on an air bearing arrangement in accordance with an embodiment of the present invention.

FIG. 3a is a diagrammatic representation of fine stage which is supported on air bearings and has six degrees of freedom in accordance with an embodiment of the present invention.

FIG. 3b is a cross-sectional side view block diagram representation of an overall stage assembly which includes a fine stage assembly which may be actuated in a direction in which it is supported on air bearings, e.g., fine stage assembly 300 of FIG. 3a, in accordance with an embodiment of the present invention.

FIG. 3c is a diagrammatic top view representation of an overall stage assembly which includes a fine stage assembly which may be actuated in a direction in which it is supported on air bearings, e.g., fine stage assembly 300 of FIG. 3a, in accordance with an embodiment of the present invention.

FIG. 3d is a diagrammatic representation of a fine stage which is supported on air bearings and has six degrees of freedom in accordance with an embodiment of the present invention.

FIG. 4a is a cross-sectional side view block diagram representation of an overall stage assembly which includes two pairs of electromagnetic actuators which provide acceleration forces and three VCMs which provide precise control forces in accordance with an embodiment of the present invention.

FIG. 4b is a diagrammatic top-view representation of a stage assembly which includes two pairs of electromagnetic actuators and three VCMs which provide precise control forces, e.g., stage assembly 395 of FIG. 4a, in accordance with an embodiment of the present invention.

FIG. 5 is a diagrammatic representation of a photolithography apparatus in accordance with an embodiment of the present invention.

FIG. 6 is a process flow diagram which illustrates the steps associated with fabricating a semiconductor device in accordance with an embodiment of the present invention.

FIG. 7 is a process flow diagram which illustrates the steps associated with processing a wafer, i.e., step 1304 of FIG. 6, in accordance with an embodiment of the present invention.

FIG. 8 is a perspective view of a dual stage system in accordance with a preferred embodiment of the present invention.

### DETAILED DESCRIPTION OF THE EMBODIMENTS

The choice of actuators to utilize in a high-precision apparatus such as a photolithography apparatus or, more specifically, a stage device included in a photolithography apparatus, often involves a trade-off between accuracy and efficiency. Typically, E-I core actuators operate with a relatively high degree of efficiency, and do not generate a significant amount of heat. However, E-I core actuators are less accurate than voice coil motors (VCMs). VCMs, while highly accurate, are less efficient than E-I core actuators, and have the tendency to generate a relatively significant amount of heat. Heat may adversely affect the performance of a stage device. Enabling a VCM to cause a fine stage that is mechanically coupled to a coarse stage within a stage device to scan during a constant velocity portion of a scan, and an E-I core actuator to cause the fine stage to accelerate and to decelerate, allows a scanning process to benefit from the use of a VCM without being significantly affected by the inefficiency of the VCM.

By enabling a six-degree of freedom fine stage of a stage device which has substantially no mechanical connections with a coarse stage of the stage device, and is supported by air bearings, to be actuated by both E-I core actuators and VCMs, the performance of the stage device may be enhanced. VCMs may be implemented to precisely control motion of the fine stage at a constant velocity in at least three degrees of freedom, while E-I core actuators may be implemented to provide acceleration and deceleration in planar degrees of freedom. A VCM may also be used to actuate the fine stage in at least one degree of freedom that is supported by the air bearings. A stage device may benefit from the efficiency of an E-I core actuator during acceleration and deceleration, or during positive acceleration and negative acceleration, of a fine stage, and benefit from the accuracy of VCMs during precise positioning of the fine stage.

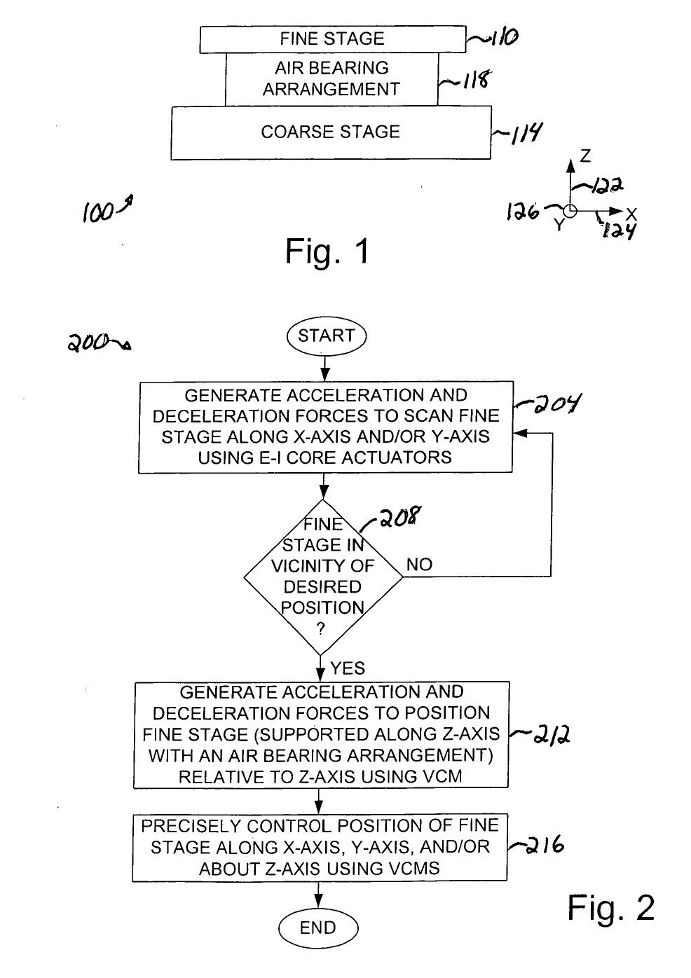

FIG. 1 is block diagram representation of a fine stage that is supported on a coarse stage by an air bearing arrangement in accordance with an embodiment of the present invention. A stage arrangement 100 includes a fine stage 110 and a coarse stage 114. A fine stage 110 is generally arranged to impart fine motions associated with scanning an object (not shown) supported on the stage, while coarse stage 114 is arranged to impart coarse motions associated with scanning the object. While fine stage 110 may be a wafer table that is arranged to support a wafer (not shown), it should be appreciated that fine stage 110 may be arranged to support substantially any object which is to be used in a scanning process. By way of example, fine stage 110 may be a stage that is arranged to support a reticle that is used in a lithography process.

In the described embodiment, fine stage 110 has substantially no mechanical connections to coarse stage 114. That is, there are generally no wires or tubes that connect fine stage 110 to coarse stage 114, i.e., fine stage 110 is a tubeless fine stage relative to coarse stage 114. Fine stage 110 is typically formed from a material which has a relatively high stiffness structure, e.g., fine stage 110 may be a ceramic box structure. Fine stage 110 is supported in a z-direction 122 by an air bearing arrangement 118 which enables fine stage 110 to translate relative to an x-direction 124 and a y-direction 126 on an air bearing surface. As shown, air bearing arrangement 118 is arranged to be positioned atop coarse stage 114. It should be appreciated that air bearing arrangement 118 may include any number of air bearings.

Fine stage 110 has six degrees of freedom. In other words, fine stage 110 is arranged to translate in z-direction 122, in x-direction 124, in y-direction 126, about z-axis or z-direction 122, about x-axis or x-direction 124, and about y-axis or y-direction 126. Although fine stage 110 is supported by air bearing arrangement 118 in z-direction 122, fine stage 110 is arranged to be actuated in z-direction 122 by a VCM or, more generally, an electromagnetic actuator which has a relatively high degree of accuracy. In one embodiment, each air bearing included in air bearing arrangement 118 may be driven by a separate VCM.

With reference to FIG. 2, one method of positioning a fine stage that is supported on an air bearing arrangement will be described in accordance with an embodiment of the present invention. A method 200 of positioning a fine stage begins at step 204 in which acceleration or deceleration forces, as appropriate, are generated to scan the fine stage along a planar axis, i.e., an x-axis or a y-axis. That is, relatively coarse position of the fine stage is accomplished in step 204. In general, the actuators which enable the fine stage to accelerate to and decelerate are electromagnetic actuators with a relatively high degree of efficiency, but typically a lower degree of accuracy. One suitable type of actuator that enables the fine stage to accelerate and to decelerate is an E-I core actuator.

Once the fine stage is scanned along one or both planar axes using high efficiency actuators, a determination is made in step 208 regarding whether the fine stage is in the vicinity of a desired position. Such a determination may be based on the amount by which the actual position of the fine stage and the desired position of the fine stage vary. If it is determined that the fine stage is not in the vicinity of the desired position, then process flow returns to step 204 in which the high efficiency actuators are once again used to enable the fine stage to scan along the planar axes.

Alternatively, if it is determined in step 208 that the fine stage is in the vicinity of the desired position, then the indication is either that it is unnecessary to move the fine stage further, or that some fine tuning of the position would allow the desired position to be achieved. Accordingly, in step 212, acceleration and deceleration forces, as necessary, may be provided by a high accuracy actuator such as a VCM to move the fine stage relative to a z-axis, or in a direction in which the fine stage is supported by an air bearing arrangement. Once the fine stage is moved along the z-axis to a desired position with respect to the z-axis, the position of the fine stage may be precisely controlled, or otherwise fine tuned, in step 216. The precise control of the fine stage is achieved, in the described embodiment, by high accuracy actuators such as VCMs. VCMs may be used to precisely control the position of a fine stage along an x-axis and a long a y-axis, as well as the rotational position about a z-axis. After the position of the fine stage is controlled using VCMs, the process of positioning the fine stage is completed.

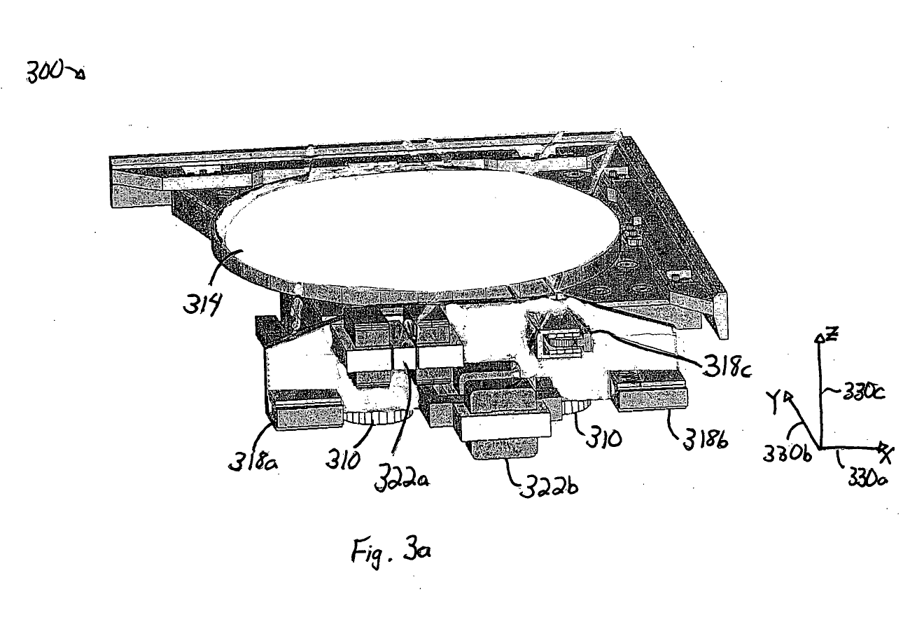

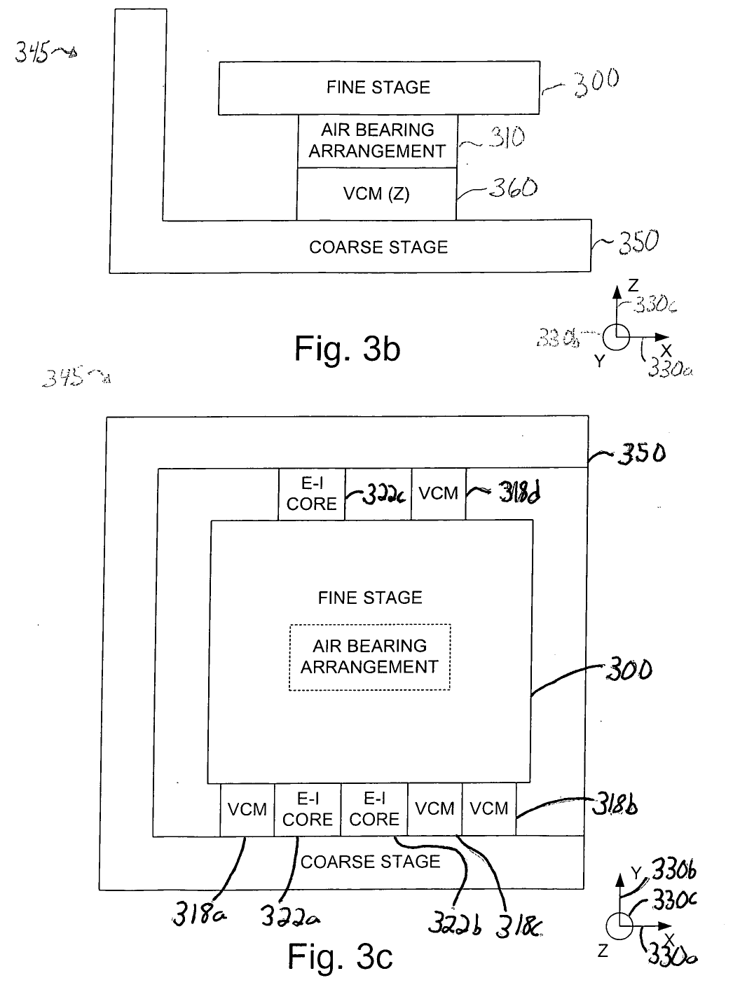

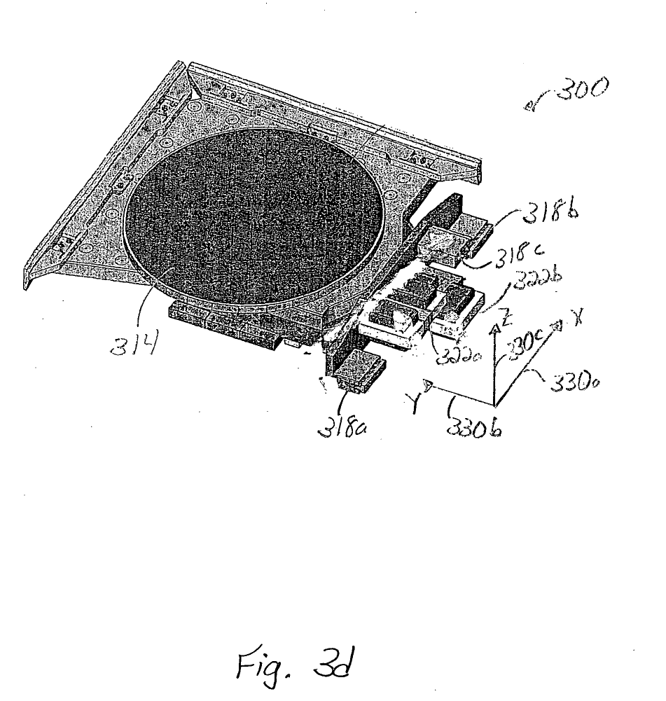

In general, a fine stage which is supported on air bearings relative to a z-axis and has planar actuators may have a variety of different configurations. FIG. 3a is a diagrammatic representation of fine stage which is supported on air bearings and has six degrees of freedom in accordance with an embodiment of the present invention. Also, FIG. 3d is a diagrammatic representation of the fine stage shown in FIG. 3a under an alternate view. A fine stage assembly 300 includes a holder 314 on which a wafer (not shown), or an object to be scanned, may be supported. Fine stage assembly 300 or, more specifically, holder 314 may be formed as a ceramic box structure, and is supported relative to a z-axis 330c by an air bearing arrangement 310 which includes air bearings.

As fine stage assembly 300 is arranged to have up to six degrees of freedom, various actuators are arranged to provide forces which enable fine stage assembly 300 to move. Planar degrees of freedom are effectively arranged to be servoed directly by high efficiency pairs of electromagnetic actuators 322a, 322b. Electromagnetic actuator pair 322a, which may be a pair of E-I core actuators, is arranged to substantially directly servo fine stage assembly 300 and enable fine stage assembly 300 to scan along an x-axis 330a. Electromagnetic actuator pair 322b, which may also be a pair of E-I core actuators, is arranged to enable fine stage assembly 300 to scan along a y-axis 330b. In general, fine stage assembly 300 may include an additional pair of electromagnetic actuators, i.e., electromagnetic actuators 322c of FIG. 3c, which are arranged to cooperate with electromagnetic actuators 322a to allow for scanning along x-axis 330a. One example of E-I core actuators is described in U.S. Pat. No. 6,069,417, which is incorporated herein by reference in its entirety.

While pairs of electromagnetic actuators 322a, 322b are arranged to generate high forces with relatively low heat to accelerate and to decelerate fine stage assembly 300 along x-axis 330a and y-axis 330b, respectively, during a non-constant velocity portion of a scan, pairs of electromagnetic actuators 322a, 322b are not arranged to be used during a constant velocity portion of a scan. High accuracy, but relatively low force, electromagnetic actuators 318a-c are arranged to be used during a constant velocity portion of a scan to precisely position a wafer (not shown) supported on holder 314. Typically, electromagnetic actuators 318a-c are relatively low force, relatively light, and precisely controllable. Actuators 318a-c used for fine control of fine stage assembly 300 are typically VCMs, as VCMs are linear force motors that are relatively small, and relatively easy to control.

As shown, actuator 318a and actuator 318b are both VCMs which enable fine stage assembly 300 to be precisely controlled relative to y-axis 330b. While actuators 318a, 318b may each precisely position fine stage assembly 300 along y-axis 330b, actuators 318a, 318b may also cooperate to precisely position fine stage assembly 300 along y-axis 330b, and about z-axis 330c. When actuator 318a and actuator 318b are actuated such that there is a differential in the forces generated by actuator 318a and actuator 318b, a torque may be created about z-axis 330c, i.e., rotational motion about z-axis 330c may be created through actuating actuator 318a and actuator 318b. That is, differential control of actuators 318a, 318b such that a “delta” is created enables fine stage assembly 300 to be precisely positioned about z-axis 240c.

Actuator 318c is a VCM that is arranged to enable fine control relative to x-axis 330a. It should be appreciated that while three actuators 318a-c have been shown in FIG. 3a and described as enabling fine control of fine stage assembly 300 along x-axis 330a, along y-axis 330b, and about z-axis 330c, fine stage assembly 300 may also include an additional VCM such as a VCM 318d of FIG. 3c, which may cooperate with VCM 318c to enable a precise control force to be generated along x-axis 330a. VCMs 318c, 318d may also be actuated differentially to generate some rotational motion about z-axis 330c.

In the described embodiment, low force electromagnetic actuators such as VCMs (not shown) are used to enable fine stage assembly 300, which is supported on air bearing relative to z-axis 330c, to be actuated along z-axis 330c. The number of electromagnetic actuators that enable the precise control of the position of fine stage assembly 300 relative to z-axis 330c may vary widely.

Referring next to FIGS. 3b and 3c, the positioning of actuators relative to a coarse stage and a fine stage, i.e., fine stage assembly 300 of FIG. 3a, that is supported in a z-direction by air bearings will be described in accordance with an embodiment of the present invention. FIG. 3b is a cross-sectional side view block diagram representation of an overall stage assembly in accordance with an embodiment of the present invention, and FIG. 3c is a diagrammatic top-view of the stage assembly of FIG. 3b in accordance with an embodiment of the present invention. An overall stage assembly 345 includes a coarse stage 350 and fine stage 300, which is positioned over coarse stage 350. Fine stage 300 is supported relative to z-axis 330c by air bearing arrangement 310, as previously mentioned.

At least one VCM 360 is arranged to actuate fine stage 300 along z-axis 330c, i.e., VCM 360 is arranged to cause fine stage 300 to be actuated in a direction that is supported by air bearing arrangement 310. A plurality of VCMs 318a-d cooperate to enable fine stage 300 to be precisely controlled. VCMs 318a, 318b enable fine stage 300 to be controlled along y-axis 330b and also about z-axis 330c, while VCMs 318c, 318d enable fine stage 300 to be controlled along x-axis 330a and also about z-axis 330c. Pairs of electromagnetic actuators 322a-c are positioned such that actuators 322a, 322c may cooperate to enable force to be generated to accelerate fine stage 300 along x-axis 330a, while actuator 322b generates force to accelerate fine stage 300 along y-axis 330b. In the described embodiment, actuators 322a-c are arranged to substantially directly drive, or directly servo, fine stage 300, and VCMs 318a-d are arranged to substantially directly control fine stage 300. VCM 360 indirectly drives fine stage 300, as VCM 360 controls fine stage 300 by controlling the position of air bearing arrangement 310 relative to z-axis 330c. VCM 360 may also be configured to directly drive fine stage 300.

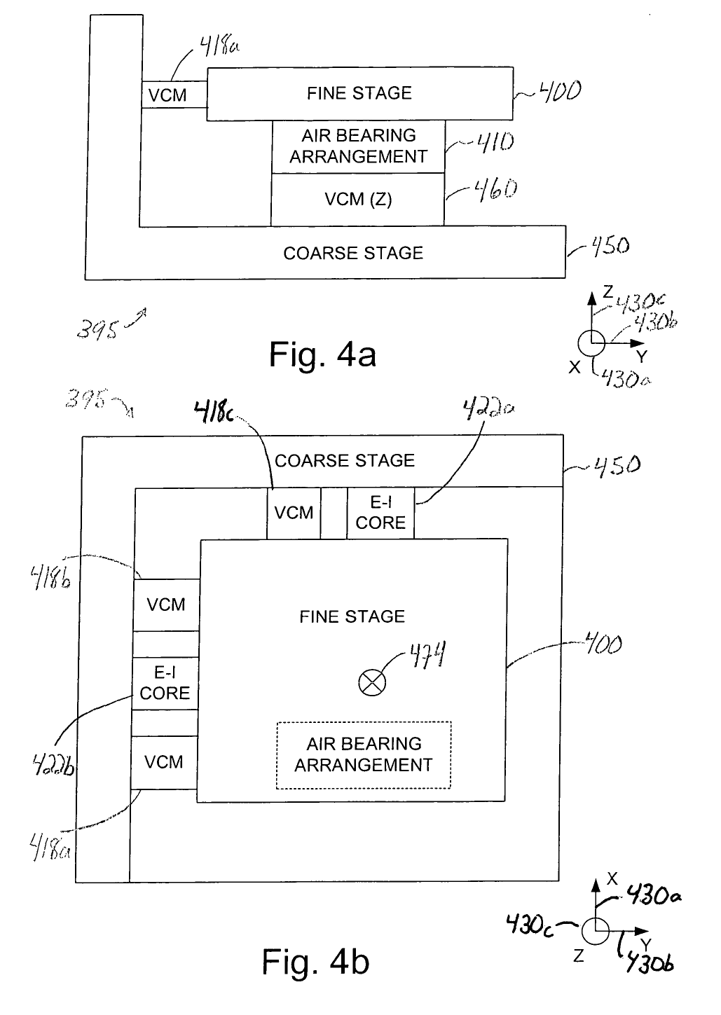

In general, the number of actuators in a dual force fine stage or wafer table may vary depending upon the orientation of the actuators. For example, as discussed above with respect to FIGS. 3a-c, a fine stage may be driven in planar degrees of freedom by three pairs of electromagnetic actuators such as E-I core actuators, and may be precisely controlled in planar degrees of freedom and a rotational degree of freedom using four VCMs. However, a dual force fine stage may include fewer pairs of electromagnetic actuators and fewer VCMs. With reference to FIGS. 4a and 4b, a dual force fine stage apparatus will be described in accordance with a second embodiment of the present invention. FIGS. 4a and 4b are cross-sectional side view and top view, respectively, block diagram representations of a stage assembly which includes two pairs of electromagnetic actuators, as well as three VCMs to provide precise control of planar degrees of freedom and one rotational degree of freedom, in accordance with an embodiment of the present invention. A stage apparatus 395 includes a coarse stage 450 and a fine stage 400 which has substantially no mechanical connections to coarse stage 450. Fine stage 400 is supported over coarse stage 450 by an air bearing arrangement 410, and may be actuated along a z-axis 430c by a VCM arrangement 460 which may include any number of VCMs. That is, fine stage 400 may be actuated by VCM arrangement 460 in a direction in which fine stage 400 is supported by air bearing arrangement 410.

Pairs of electromagnetic actuators 422a, 422b, which are pairs of E-I core actuators in the described embodiment, generate acceleration forces with respect to an x-axis 430a and a y-axis 430b. Pairs of electromagnetic actuators 422a, 422b are arranged substantially only to provide fine stage 400 acceleration with respect to x-axis 430a and y-axis 430b. Hence, if pairs of electromagnetic actuators 422a, 422b are arranged to push through a center of gravity 474 of fine stage 400, then pair of electromagnetic actuators 422b is typically sufficient to provide acceleration along x-axis 430a and pair of electromagnetic actuators 422a is typically sufficient to provide acceleration along y-axis 430b. That is, if acceleration forces are provided through center of gravity 474, then two pairs of E-I core actuators are generally adequate for enabling fine stage 400 to accelerate along planar axes.

VCMs 418a-c are arranged to provide control forces which enable the motion, e.g., constant velocity motion, of fine stage 400 to be precisely controlled. Either or both VCM 418a and VCM 418b may be used to provide precise control forces relative to x-axis 430a. If both VCMs 418a, 418b are used to provide precise control forces, VCMs 418a, 418b are actuated substantially with the same force. When VCMs 418a, 418b are actuated differentially, e.g., with different amounts of force, rotational motion about z-axis 430c may be achieved. VCM 418c is arranged to provide a precise control force that enables fine stage 400 to be controlled along y-axis 430b.

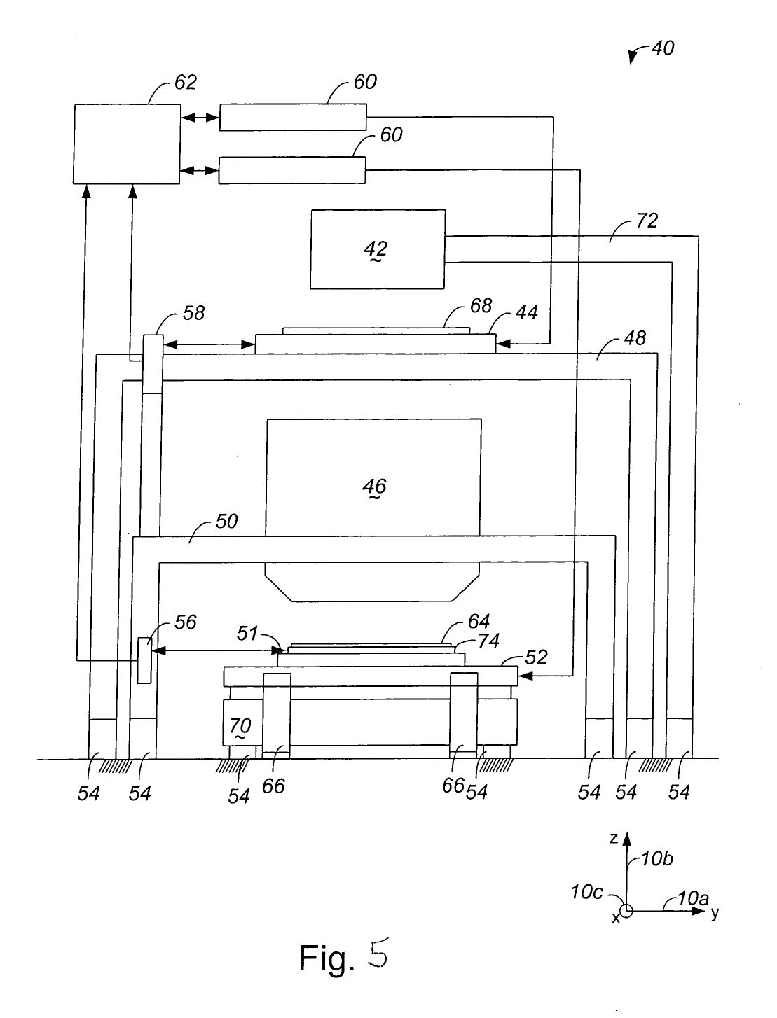

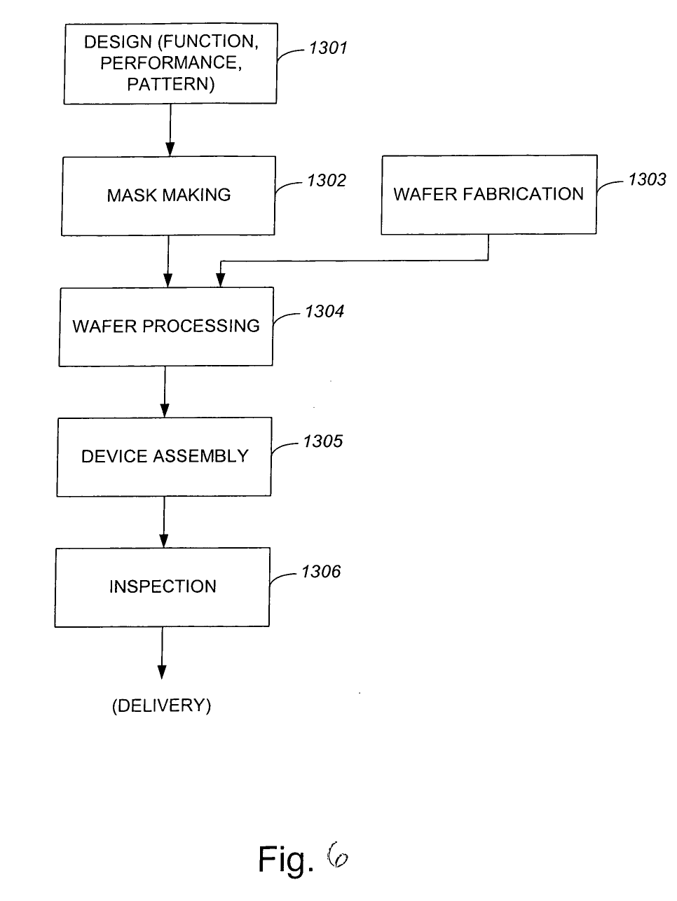

With reference to FIG. 5, a photolithography apparatus will be described in accordance with an embodiment of the present invention. A photolithography apparatus (exposure apparatus) 40 includes a wafer positioning coarse stage 52 that may be driven by a planar motor as well as a fine stage or a wafer table 51 that has no mechanical coupling to wafer positioning coarse stage 52. The planar motor which drives wafer positioning stage 52 generally uses an electromagnetic force generated by magnets and corresponding armature coils arranged in two dimensions. A wafer 64 is held in place on a wafer holder or chuck 74 which is coupled to wafer table 51. Wafer positioning coarse stage 52 is arranged to move in multiple degrees of freedom, e.g., between three to six degrees of freedom, under the control of a control unit 60 and a system controller 62. The movement of wafer positioning coarse stage 52, as well as the precise control of wafer table 51, allows wafer 64 to be positioned at a desired position and orientation relative to a projection optical system 46.

Wafer table 51 may be a fine stage, as previously mentioned. Wafer table 51 may be supported in z-direction 10b by air bearings and is driven relative to z-direction 10b using VCMs. The motor array of wafer positioning coarse stage 52 is typically supported by a base 70. Base 70 is supported to a ground via isolators 54.

An illumination system 42 is supported by a frame 72. Frame 72 is supported to the ground via isolators 54. Illumination system 42 includes an illumination source, and is arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly. The present invention may be utilized in an immersion type exposure apparatus by incorporating suitable measures to accommodate a liquid. For example. PCT Patent Application WO 99/49504 discloses an exposure apparatus in which a liquid is supplied to a space between a substrate such as a wafer and a projection lens system in an exposure process. As far as is permitted, the disclosures in PCT Patent Application WO 99/49504 is incorporated herein by reference.

Further, the present invention may be utilized in an exposure apparatus that comprises two or more substrate and/or reticle stages. In such apparatuses, the additional stage may be used in parallel or preparatory steps while the other stage is being utilized for an exposure process. Multiple stage exposure apparatuses are described, for example, in Japan Patent Application Disclosure No. 10-163099 and in Japan Patent Application Disclosure No. 10-214783, as well as in their counterpart U.S. Patents which include U.S. Pat. No. 6,341,007, U.S. Pat. No. 6,400,441, U.S. Pat. No. 6,549,269, and U.S. Pat. No. 6,590,634. In addition, a multiple stage exposure apparatus is described in Japan Patent Application Disclosure No. 2000-505958 and its counterparts U.S. Pat. No. 5,969,441 and U.S. Pat. No. 6,208,407. As far as is permitted, each of the disclosures in the above-mentioned U.S. Patent and Japan Patent Application Disclosures are incorporated herein by reference.

The present invention may also be utilized in an exposure apparatus that has a movable stage which retains a substrate such as a wafer for exposure, and a stage having various sensors or measurement tools for measuring, as described in Japan Patent Application Disclosure No. 11-135400. As far as is permitted, the disclosure in the above-mentioned Japan Patent Application Disclosure is incorporated herein by reference.

FIG. 9 is a perspective view of a dual stage system according to another embodiment of the present invention. In the embodiment as shown, two fine stages may be positioned on coarse stages. The fine stages may be substantially independently coarsely positioned using coarse stages, and may each be configured according to any of the above-described embodiments. Although identical fine stages are typically preferable, it should be appreciated that the fine stages in a dual stage system may also be different. In addition, the number of fine stages in a stage system may vary widely, e.g., more than two fine stages may generally be included in a multi-stage system.

A photolithography system according to the above-described embodiments, e.g., a photolithography apparatus which may includes a dual force wafer table or fine stage, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

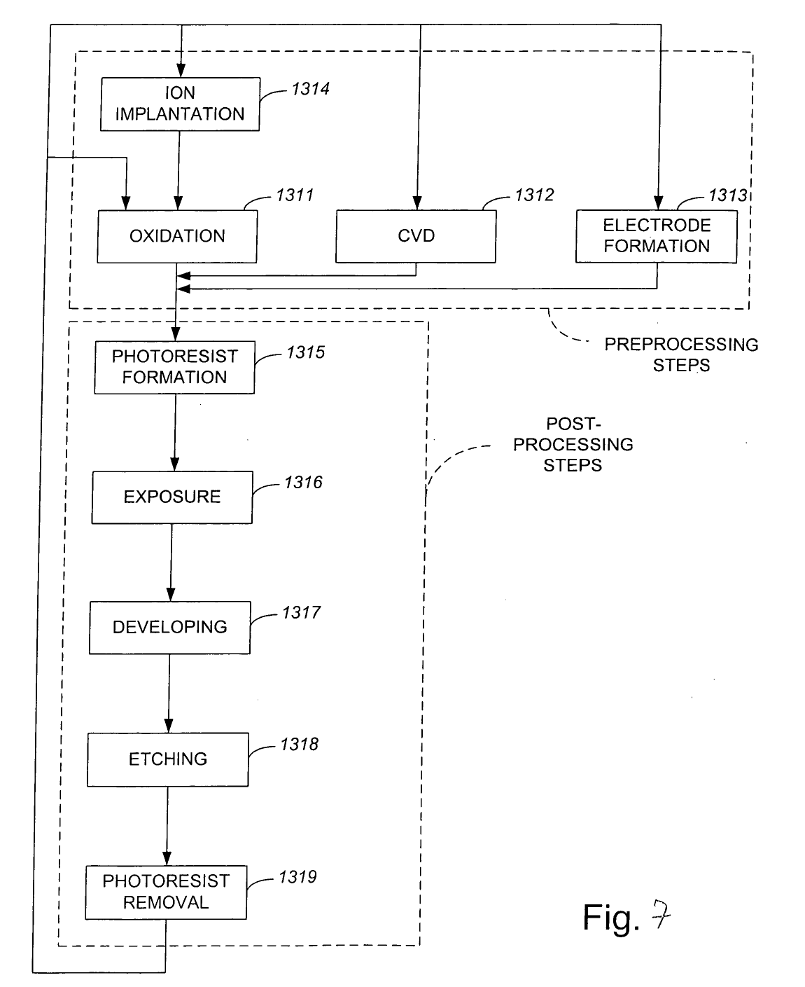

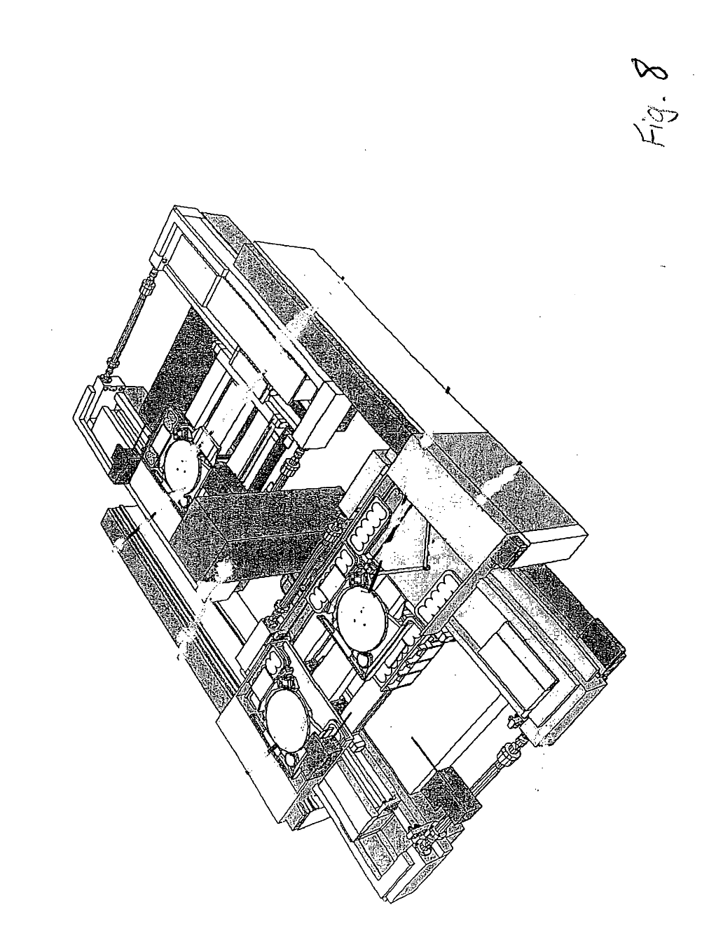

Further, semiconductor devices may be fabricated using systems described above, as will be discussed with reference to FIG. 6. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 7. In step 1305, the semiconductor device is assembled. The assembly of the semiconductor device generally includes, but is not limited to, wafer dicing processes, bonding processes, and packaging processes. Finally, the completed device is inspected in step 1306.

FIG. 7 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while a fine stage of the present invention has generally been described as being a wafer positioning stage, the fine stage may instead be used as a reticle positioning stage.

A VCM arrangement which may include one or more VCMs has generally been described as being suitable for use in driving a fine stage relative to a direction in which the fine stage is supported by air bearings. While a VCM arrangement is particularly suitable for such a purpose, other types of actuators may instead be used to drive the fine stage relative to the direction in which the fine stage is supported by air bearings, e.g., a z-direction.

A tubeless fine stage is supported in a z-direction by an air bearing arrangement which includes at least one air bearing. While only the degree of freedom associated with a z-direction has been described as being supported by an air bearing arrangement, it should be appreciated that other degrees of freedom of a fine stage may also be supported on an air bearing arrangement.

The steps associated with using a fine stage of the present invention may be widely varied. By way of example, precise control of a fine stage along an x-axis, a y-axis, or about a z-axis may occur before precise control of the fine stage along a z-axis. Alternatively, precise control of the fine stage along an x-axis, a y-axis, and a z-axis may occur substantially simultaneously without departing from the spirit or the scope of the present invention. Therefore, the present examples are to be considered as illustrative and not restrictive, and the invention is not to be limited to the details given herein, but may be modified within the scope of the appended claims.

What is claimed is:

1. A stage device comprising:
a first stage;
an air bearing arrangement, the air bearing arrangement including at least one air bearing;
a second stage, the second stage being arranged to have approximately six degrees of freedom, the second stage being supported relative to the first stage in a first degree of freedom of the approximately six degrees of freedom by the air bearing arrangement;
a first actuator arrangement, the first actuator arrangement being arranged to provide a force to drive the second stage in the first degree of freedom;
a second actuator arrangement, the second actuator arrangement being arranged to drive the second stage in at least a first planar degree of freedom of the approximately six degrees of freedom; and
a third actuator arrangement, the third actuator arrangement being arranged to control the second stage in the first planar degree of freedom and a second planar degree of freedom of the approximately six degrees of freedom, the third actuator arrangement further being arranged to control the second stage in a first rotational degree of freedom of the six degrees of freedom, the first rotational degree of freedom being about an axis associated with the first degree of freedom.

2. The stage device of claim 1 wherein the first actuator arrangement includes at least a first voice coil motor (VCM).

3. The stage device of claim 1 wherein the second actuator arrangement includes at least a first pair of electromagnetic actuators which produces a relatively high force and the third actuator arrangement includes at least a second electromagnetic actuator which produces a relatively low force.

4. The stage device of claim 3 wherein the first pair of electromagnetic actuators is a pair of E-I core actuators and the second electromagnetic actuator is a VCM.

5. The stage device of claim 1 wherein the second actuator arrangement is further arranged to drive the second stage in the second planar degree of freedom.

6. The stage device of claim 1 wherein the first stage and the second stage are not coupled by a mechanical connection.

7. The stage device of claim 1 wherein the fine stage is a ceramic box structure.

8. An exposure apparatus comprising the stage device of claim 1.

9. A device manufactured with the exposure apparatus of claim 8.

10. A wafer on which an image has been formed by the exposure apparatus of claim 8.

11. A method for positioning an object using a stage device, the stage device including a fine stage and a coarse stage wherein the fine stage has no mechanical connection to the coarse stage and supports the object, the fine stage being supported in a z-direction by an air bearing arrangement, the fine stage further having approximately six degrees of freedom, the six degrees of freedom including a translational degree of freedom in the z-direction, the method comprising:
imparting acceleration on the fine stage to cause the fine stage to accelerate in at least one of an x-direction and a y-direction using a relatively high force actuator arrangement;
imparting at least one approximately constant velocity on the fine stage using a relatively low force actuator arrangement, the at least one approximately constant velocity being imparted to causing the fine stage to move in at least one of the x-direction, the y-direction, and a rotational direction about the z-direction in which the fine stage is supported by the air bearing arrangement; and
imparting a velocity on the fine stage using at least a first actuator, the first actuator being arranged to cause the fine stage to translate in the z-direction in which the fine stage is supported by the air bearing arrangement.

12. The method of claim 11 wherein the relatively high force actuator arrangement includes at least one E-I core actuator and the relatively low force actuator arrangement includes at least one voice coil motor (VCM).

13. The method of claim 11 wherein the relatively high force actuator arrangement includes at least one pair of E-I core actuators and the relatively low force actuator arrangement includes at least three VCMs.

14. The method of claim 12 wherein the first actuator is a VCM.

15. The method of claim 12 wherein imparting the at least one approximately constant velocity to cause the fine stage to move includes generating at least one control force in at least one of the x-direction, the y-direction, and the rotational direction about the z-direction.

16. A method for operating an exposure apparatus comprising the method for positioning of claim 11.

17. A stage device comprising:
a surface;
an air bearing arrangement, the air bearing arrangement including at least one air bearing;
a fine stage, the fine stage being arranged to have approximately six degrees of freedom, the fine stage being supported relative to the surface in a first translational direction by the air bearing arrangement, wherein the fine stage is a tubeless fine stage relative to the first surface;
a first voice coil motor (VCM), the first VCM being arranged to provide a force to actuate the fine stage in the first translational direction;
an E-I core actuator arrangement, the E-I core actuator arrangement being arranged to provide an acceleration to drive the fine stage in at least a second translational direction; and
a VCM arrangement, the VCM arrangement including at least a second VCM, the VCM arrangement being arranged to drive the fine stage in at least one of the second translational direction, a third translational direction, and a first rotational direction, the first rotational direction being about an axis associated with the first translational direction.

18. The stage device of claim 17 wherein the VCM arrangement includes at least three VCMs.

19. The stage device of claim 17 wherein the surface is part of a coarse stage.

20. The stage device of claim 17 wherein the VCM arrangement further includes a third VCM and a fourth VCM.

21. The stage device of claim 17 wherein the E-I core actuator arrangement includes at least one pair of E-I core actuators, the E-I core actuator arrangement being arranged to generate an acceleration force during a non-constant velocity portion of a scan.

22. The stage device of claim 21 wherein the VCM arrangement is arranged to drive the fine stage with at least one approximately constant velocity during a constant velocity portion of a scan.

23. The stage device of claim 21 wherein the E-I core actuator arrangement is arranged to directly servo the fine stage in at least the second translational direction.

24. The stage device of claim 17 wherein the E-I core actuator arrangement is further arranged to drive the fine stage in the third translational direction.

25. The stage device of claim 17 wherein the fine stage is a ceramic box structure.

26. An exposure apparatus comprising the stage device of claim 17.

27. A device manufactured with the exposure apparatus of claim 17.

28. A wafer on which an image has been formed by the exposure apparatus of claim 27.
